(19) United States
(12) Patent Application Publication
(10) Pub. No.: US 2013/0152448 A1
(43) Pub. Date: Jun. 20, 2013

(54) Automatic bait cover and method of baiting

(71) Applicant: Terry S. Ewert, Abbotsford, WI (US)

(72) Inventor: Terry S. Ewert, Abbotsford, WI (US)

(21) Appl. No.: 13/720,276

(22) Filed: Dec. 19, 2012

Related U.S. Application Data
(60) Provisional application No. 61/577,930, filed on Dec. 20, 2011.

(51) Int. Cl. A01M 31/00

(52) U.S. Cl. CPC A01M 31/008
USPC 43/2

(57) ABSTRACT

A bait cover to control the exposure of bait to wildlife by providing a selected quantity of bait on a ground surface and positioning the bait cover, comprising a movable cover in sufficient proximity to the bait such that the movable cover covers the bait in a first position and exposes the bait sufficiently for wildlife to feed on in a second position; a swing arm connected to the movable cover; and a controller connected to the base end of the swing arm to control movement of the swing arm and the movable cover between a covered and uncovered position, wherein the controller includes an automatic timer to control operation of the bait cover.

### BACKGROUND OF THE INVENTION

The present application claims the benefit of U.S. provisional patent application Ser. No. 61/577,930, filed Dec. 20, 2011, the content of which is hereby incorporated by reference in its entirety.

This disclosure relates to the practice of baiting wild game as part of hunting. In particular, this disclosure relates to baiting wild game with bait piles wherein the bait is provided to wild life for a specific time period.

It is widely known by hunters that baiting has an advantage over traditional hunting methods. Baiting not only increases the chances of seeing wild life but also increases the chances of harvesting wild game such as deer.

Generally in states where baiting is legal, hunters set out large piles of bait in order to attract as many targets as possible over the duration of a hunt. Increasing the traffic of targets will lead to increased yield when hunting. The general practice by hunters has been to set out a large enough pile of bait to ensure that wildlife is attracted. Once the pile is set out, any type of wild life is essentially free to graze the bait until the bait has been eaten. There is no control as to when the bait is available to the deer or the duration of time the bait is available to the deer.

In some areas of the country, disease such as Chronic Wasting disease (CWD) is a problem. CWD can be transmitted through animal to animal contact as well as contamination of food sources by infected deer. Leaving open large piles of food for multiple deer or wildlife to graze greatly increases the chance of wildlife contacting each other thereby passing on the disease.

### SUMMARY OF THE INVENTION

The present invention comprises a bait cover which is used to control the exposure time of wildlife bait to wildlife. A selected quantity of bait is provided on a ground surface. The bait cover comprises a movable cover in sufficient proximity to the bait such that the movable cover covers the bait in a first position and exposes the bait sufficiently for wildlife to feed on in a second position. A swing arm is connected to the movable cover and a controller is connected to the base end of the swing arm to control movement of the swing arm and the movable cover between a covered and uncovered position. The controller can include an automatic timer to control operation of the bait cover.

### DESCRIPTION OF THE DRAWINGS

FIG. 1 is a schematic of the electrical components of the control device.

FIG. 2 is a perspective view of the bait cover in a first position.

FIG. 3 is a perspective view of the control device.

FIG. 4 is a side view of control device and ground attachment mechanism.

FIG. 5 is top view of the bait cover in a first position.

FIG. 6 is a side view of the bait cover in a first position.

### DETAILED DESCRIPTION OF THE INVENTION

This disclosure describes an automatic bait cover and method of baiting that allows exposure of the bait for a controlled period of time. Specifically, when the hunter is observing the target spot, open-ended exposure of the bait is eliminated. The method described herein provides the bait at a selected time and also for a selected duration of time by covering the bait, thereby preventing the wildlife from further consuming the bait. An audible tone, or bell, is activated during operation to uncover the bait in order to get the attention of, and attract wildlife to the bait. Controlled exposure reduces potential disease transmission from contamination of uncovered piles of bait by limiting the duration of time that the bait is available, and thereby reducing the amount of time that wildlife such as deer congregate over the bait.

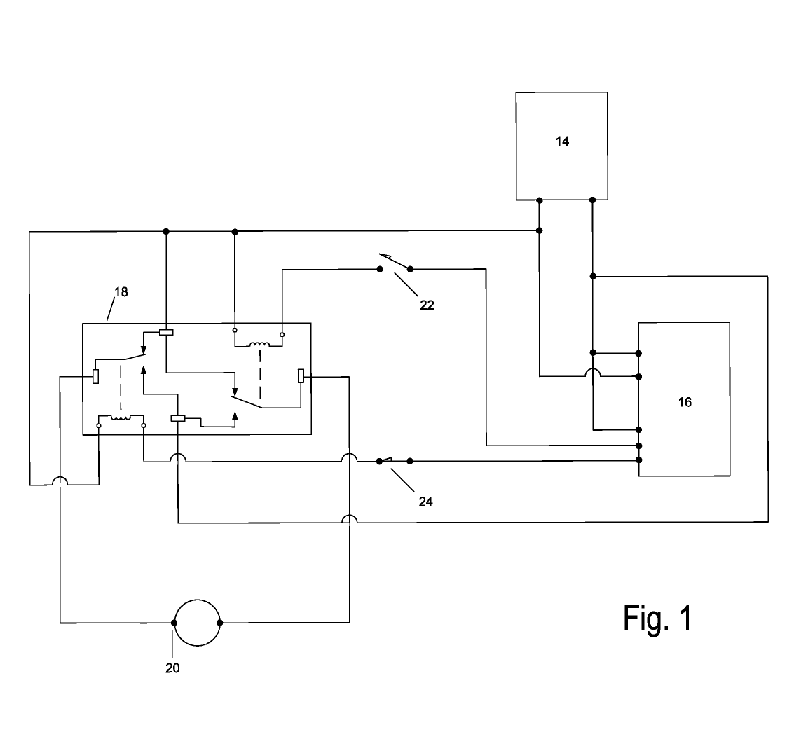

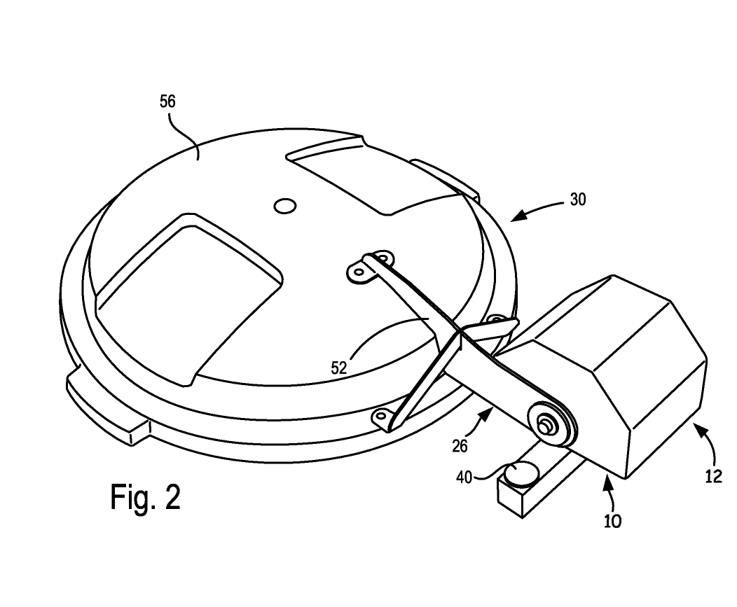

As illustrated in FIGS. 1 and 2, the present invention generally is a self-contained battery operated device that opens and closes a cover 30 based on a user settable timer 16. The first main component is an enclosure box 10. The enclosure box 10 is constructed of aluminum or other suitable metal and has a completely removable lid 12 for access to the internal parts. The enclosure box 10 includes the mechanical and electrical operating elements. The second main component is a cover 30. The cover is made of plastic or other suitable lightweight material. The cover 30 is displaceable 180 degrees so as to open and close over an intended area. A piezoelectric beeper (not shown) or other suitable mechanical bell is activated while the cover 30 opens. The cover 30 and enclosure box 10 are connected by the third main component, a cover swing arm 26. The invention is then secured to a chosen spot on the ground by two stakes 40 and 42 attached to the enclosure box 10.

As illustrated in FIGS. 1, 3, 4 and 5 the enclosure box 10 houses the electrical components. In more detail, FIG. 1 illustrates the power circuitry associated with one embodiment of the invention. Power circuitry for the invention can include any suitable circuitry for providing power from the battery to the components in the enclosure box 10. The enclosure box 10 holds a battery 14, a timer 16, a circuit relay board 18 and a gear motor 20. The circuit relay board 18 has connections for the battery 14, the timer 16 and the gear motor 20. The battery 14 is wired to the timer 16 and the circuit relay board 18. The timer 16 is also wired to the circuit relay board 18. The gear motor 20 is wired to the circuit relay board 18. The timer 16 controls the intervals at which the gear motor 20 will operate. Two separate limit switches 22 and 24 are wired between the timer 16 and the relay board 18 connection. The limit switches 22 and 24 act to turn off the operating gear motor 20 once the cover 30 is in the desired position. Limit switch 22 controls when the cover 30 is closing and limit switch 24 controls while the cover 30 is opening. Each limit switch 22 and 24 is connected to a limit switch connector (not shown) to seal the edge of the conduit from water or other elements. Alternatively, the timer 16 can be used to set a dwell time for the motor 20. The motor would run for a set period of time and the cover 30 would come to rest when it reaches an open or closed position by disengagement of a clutch 28 where the motor 30 would shut off immediately after a predetermined duration.

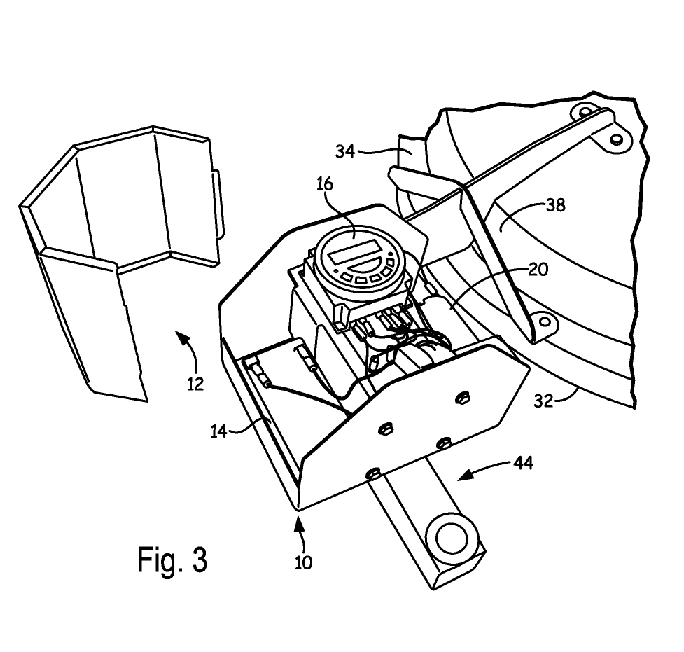

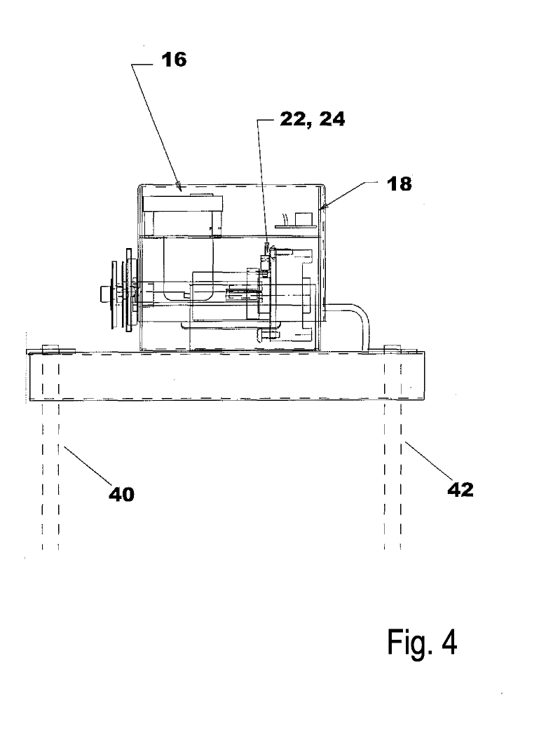

As illustrated in FIGS. 2, 3 5 and 6, the enclosure box 10 is then connected to the cover swing arm 26. The enclosure box and cover swing arm can be constructed of aluminum or other suitable metal for durability. By use of the clutch 28, the cover swing arm 26 is attached to the enclosure box 10. The clutch 28 consists of two rotating shafts (not shown). One rotating shaft is connected to the gear motor 20 inside the enclosure box 10. The other rotating shaft is connected to the swing arm 26. The clutch 28 acts to connect the gear motor 20 and the enclosure box 10, to the cover swing arm 26. The clutch 28 transfers power from the gear motor 20 to the cover swing arm 26 and limits the torque created by rotation of the cover swing arm 26 and cover 30. The manually set timer 20 initiates operation of the gear motor 20 through the relay board 18. The gear motor 20 initiates motion of the cover swing arm 26 through the clutch 28. The cover swing arm 26 can rotate up to 180 degrees as indicated by arrows 50. The limit switches 22 and 24 stop the motor and rotation of the swing arm 26 when the cover 30 reaches an open or closed position as shown in FIG. 4. In the closed position, the bait pile is covered because the cover 30 is extended over the bait pile. In the open position, the cover is displaced 180 degrees to the opposite side of the enclosure box 10 from the bait pile, completely exposing the bait pile.

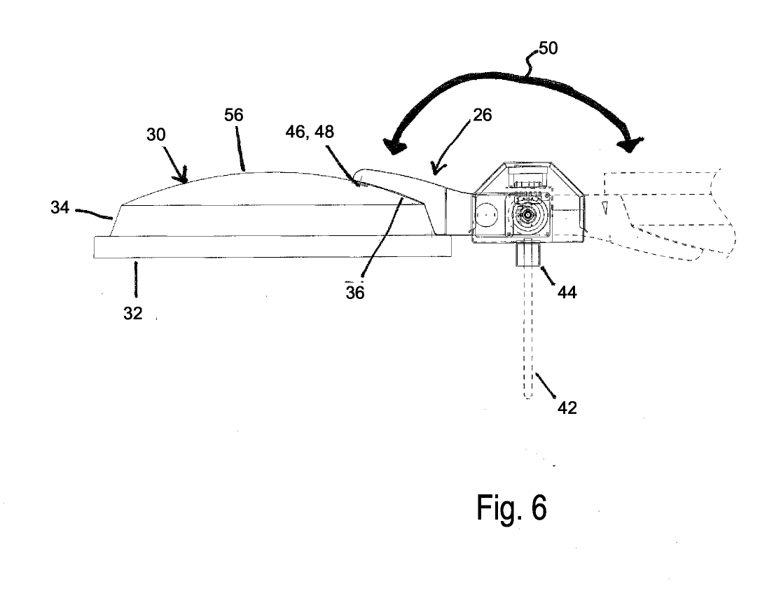

Further illustrated in FIGS. 2 and 6, the cover swing arm 26 is also connected to the cover 30. The cover 30 when closed is significantly concave in relation to the ground 54 with a raised lip 32 on the outer diameter. The raised lip 32 portion of the cover connects to a top surface 56 of the cover 30 by an approximately 90 degree angular riser 34 to give height to the top surface 56 of the cover 30. When the cover 30 is closed the top surface 56 extends over to cover the pile of bait. Simultaneously, the raised lip 32 on the outer diameter of the cover 30 makes contact with the ground. This ensures that the closed cover 30 encompasses a substantial size pile. In this instance, the ground is not limited to the earthen surface, but includes a ground surface, a material placed on the ground while underneath the bait, or a stump or other material or element in close proximity to the ground. In contrast, the cover 30 is fully open after 180 degree rotation of the cover swing arm 26 and the top surface 56 of the cover 30 is in contact with the ground surface and the pile of bait is uncovered.

In a preferred embodiment, it is contemplated that the cover would be constructed of a lightweight material that will be easily movable, but durable enough to withstand outdoor elements and attack from animals. The cover may be constructed of a durable plastic.

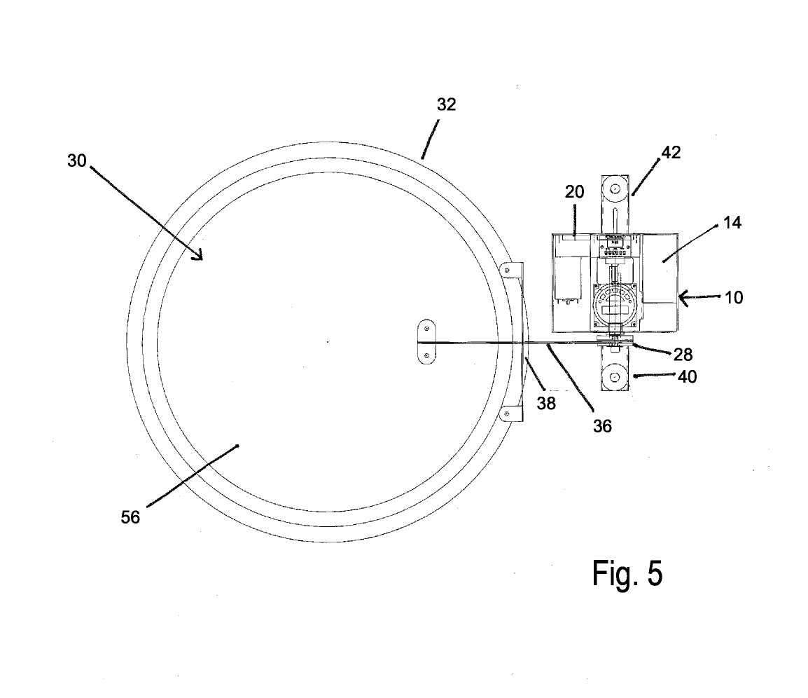

In still further detail as illustrated in FIGS. 5 and 6, the cover 30 is connected to a contoured end 36 of the cover swing arm 26. The cover swing arm 26 has a distal portion 52 having a contoured surface 36 in a concave fashion that matches the contoured in a concave fashion surface of the cover 30. The distal portion is attached to the concave surface of the cover 30 by nut 46 and bolt 48 or other suitable fastener. Additionally, a truss 38 is perpendicularly secured to the cover swing arm 26 at the edge of the cover 30. Each lower end of the truss 38 is secured to the cover 30 by nut and bolt or other suitable fastener. The truss 38 provides stability for and additional attachment support of the cover swing arm 26 to the cover 30.

As illustrated in FIG. 4 and further in FIG. 6, two aluminum or other suitable metal ground stakes 40 and 42 are attached to the underside of the enclosure box 10. The enclosure box is welded to the top of an aluminum or other suitable metal bar 44. The bar 44 extends outward from the sides underneath the enclosure box 10. The stakes 40 and 42 are attached to each end of the bar 44 perpendicular to the swing arm 26. Each stake 40 and 42 also extends into the ground to secure the enclosure box 10 and cover swing arm 26 in place. The stakes 40 and 42 also serve to resist torque of the enclosure box 10 or cover 30 during operation.

Although the present invention has been described with reference to preferred embodiments, workers skilled in the art will recognize that changes may be made in form and detail without departing from the spirit and scope of the invention.

What is claimed is:

1. A movable bait cover for covering a wildlife bait pile, the bait cover comprising:
a movable cover;
a swing arm connected to the movable cover; and
a controller connected to a base end of the swing arm to control movement of the swing arm and the movable cover from a first position to a second position;
wherein the bait cover is secured to a ground surface in proximity to the wildlife bait pile to be covered.

2. The bait cover of claim 1 wherein the movable cover is of sufficient size to cover the wildlife bait pile.

3. The bait cover of claim 1 wherein the movable cover is significantly concave in relation to the ground surface.

4. The bait cover of claim 3 wherein the movable cover is constructed of plastic.

5. The bait cover of claim 1 wherein the movable cover is securely connected to the extended portion of the swing arm by an attachment mechanism.

6. The bait cover of claim 1 wherein the swing arm is connected to the controller at the base end of the swing arm by a secure attachment mechanism.

7. The bait cover of claim 1 wherein the controller includes an automatic timer to control operation of the swing arm.

8. The bait cover of claim 6 wherein the controller is battery operated.

9. The bait cover of claim 1 wherein the controller is secured to the ground surface by at least one ground stake.

10. A method of providing bait to wildlife, the method comprising:
providing a selected quantity of bait on a ground surface;
positioning a movable cover in sufficient proximity to the bait such that the movable cover covers the bait in a first position and exposes the bait sufficiently for wildlife to feed on in a second position; and
operating a controller that controls a swing arm attached to the movable cover thereby controlling the movement of the cover between the first and second positions.

11. The method of claim 10 wherein the movable cover is sufficiently concave to cover a mound of bait.

12. The method of claim 10 wherein the moveable cover is left in the first position during non-hunting time.
